(19) United States
(12) Patent Application Publication
(10) Pub. No.: US 2025/0326613 A1
(43) Pub. Date: Oct. 23, 2025

(54) Robotic Arms on a scissor lift with conduit bending apparatus and material for installation

(71) Applicant: Joseph Homsy, Indianapolis, IN (US)

(72) Inventor: Joseph Homsy, Indianapolis, IN (US)

(21) Appl. No.: 18/423,950

(22) Filed: Apr. 20, 2024

(51) Int. Cl. B66F 7/06; B25J 18/00

(52) U.S. Cl. CPC B66F 7/065; B25J 18/00

(57) ABSTRACT

This technical abstract investigates the use of robotics in conduit hanging within the electrical union to improve efficiency and safety in installation processes. Conduit hanging is a crucial task in electrical systems, and the integration of robotics has the potential to revolutionize this aspect of the industry.

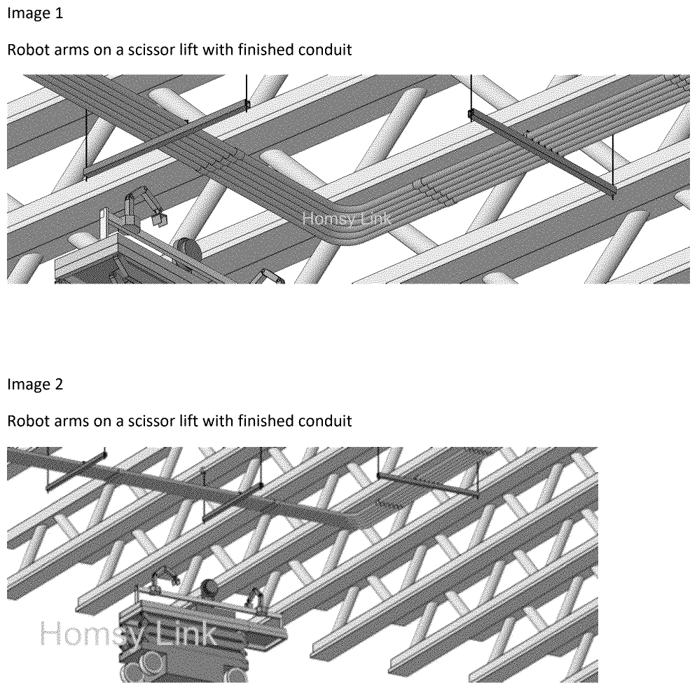

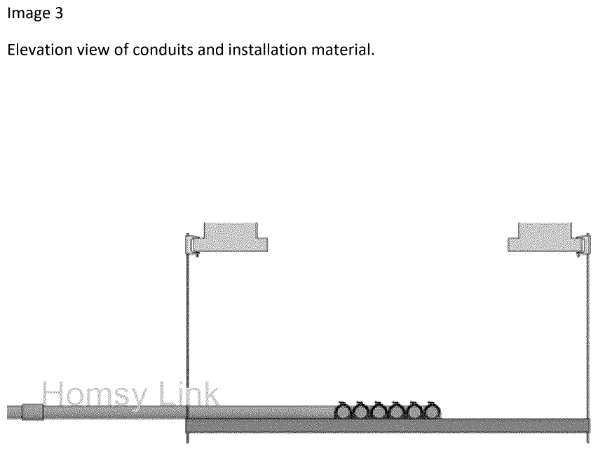

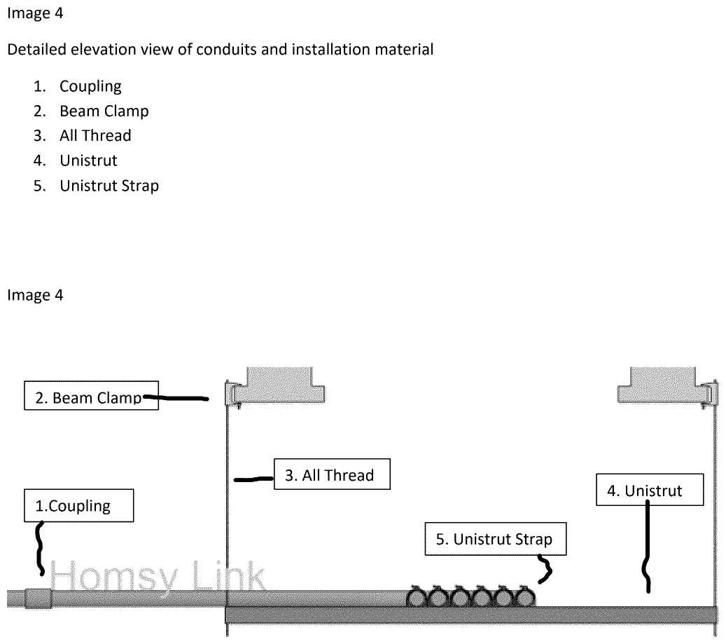

The idea for this invention was developed by examining the current practices and challenges associated with conduit hanging in the electrical union. It addresses the labor-intensive nature of this task, which often requires precise measurements, alignment, and securing of electrical conduits in various environments.

Furthermore, this invention is a basis for the different robotic technologies and systems that can be employed for conduit hanging in the electrical union. These technologies include robotic arms, automated guided vehicles (AGVs), and specialized robotic platforms designed for conduit installation and addresses their capabilities, such as the ability to measure, cut, bend, and mount conduits with precision and efficiency.

The benefits of using robotics for conduit hanging in the electrical union include improved accuracy in conduit placement, reduced installation time, and enhanced worker safety. Robotics can perform repetitive and physically demanding tasks, minimizing the risk of strain or injuries for union members. Additionally, automation can lead to cost savings by optimizing material usage and reducing rework.

However, there are challenges associated with implementing robotics for conduit hanging in the electrical union. These challenges include the initial investment cost, integration with existing workflows and systems, and the need for training union members in operating and collaborating with robotic systems.

Moreover, the importance of collaboration between union members and robotics technology providers in the development and deployment of robotic systems for conduit hanging is crucial. There is a need for open communication, knowledge sharing, and feedback loops to ensure that the technology meets the specific needs and requirements of union contractors.

In conclusion, this invention will implement the use of robotics in enhancing efficiency, safety and accuracy for conduit hanging within the electrical union. The integration of robotics can lead to improved productivity, reduced installation time, and enhanced worker safety. However, careful planning, collaboration, and training are crucial for success. Further research and industry-wide cooperation are essential for unlocking the full benefits of robotics in conduit hanging within the electrical union; this is just a small step in the right direction.

### DESCRIPTION

Robotic Arms on a scissor lift with conduit bending apparatus and material ((i.e. conduit, couplings, beam clamps, and junction boxes) to be accessibly arranged on the aerial platform for installation by the robotic arms) programmed to work in unison, while navigating through the facility

### FIELD OF INVENTION

Electrical Construction

### BACKGROUND

Being an electrician is dangerous and repetitive. Robotics programming capabilities allow for a safer way to install conduit.

### OBJECT

To safely install electrical conduit in hard-to-reach places while being controlled remotely.

1. Combination of an
aerial platform
articulated robotic arms
conduit bending apparatus
programmed together for the purpose of installing electrical conduit.
